(19) United States
(12) Patent Application Publication
(10) Pub. No.: US 2026/0103986 A1
(43) Pub. Date: Apr. 16, 2026

(54) AIRFOIL FOR AN ENGINE TURBINE

(71) Applicant: INDUSTRIA DE TURBO PROPULSORES, S.A.U., Zamudio (ES)

(72) Inventor: José Javier ÁLVAREZ GARCÍA, Zamudio (ES)

(21) Appl. No.: 19/356,474

(22) Filed: Oct. 13, 2025

(30) Foreign Application Priority Data
Oct. 15, 2024 (EP) EP24383126.0

(51) Int. Cl. F01D 5/18; F01D 5/14

(52) U.S. Cl. CPC F01D 5/187; F01D 5/147; F05D 2240/303; F05D 2240/304; F05D 2240/305; F05D 2240/306; F05D 2260/202

(57) ABSTRACT

An airfoil comprising a trailing edge being located axially downstream from a leading edge according to a flow direction. Moreover, the airfoil comprises a suction side wall and a pressure side wall extending axially between the leading edge and the trailing edge and comprising a central cavity between them. The central cavity comprises a cavity region proximal to the trailing edge wherein the cavity region comprises at least a pair of a V-shaped straight ribs extending axially towards the trailing edge, at least one narrow hole bounded by proximal ends of the pair of straight ribs, at least one wide hole bounded by the distal ends of the pair of straight ribs and at least one diffusing nozzle duct and at least one diffusing duct formed between each of the at least one pair of V-shaped straight ribs or between one V-shaped straight rib and one of the side walls.

### CROSS REFERENCE TO RELATED APPLICATIONS

This application claims priority under 35 U.S.C. § 119 (a) to foreign priority patent application EP 24383126.0, filed Oct. 15, 2024. The foreign priority patent application is hereby incorporated by reference in its entirety herein, including without limitation: the specification, claims, and abstract, as well as any figures, tables, appendices, or drawings thereof.

### TECHNICAL FIELD

The present invention belongs to the technical field of turbine airfoils, and more particularly to the cooling at the trailing edge of turbine airfoils.

In particular, the present invention proposes an airfoil dealing with a specific cooling configuration at the trailing edge of the airfoil for low cooling flow applications.

### BACKGROUND

One of the most critical problem turbomachine faces is how to prevent overheating of turbine components by cooling the turbine section using cooling fluid drawn from the compressor section.

Typically, the cooling fluid is flowed through and around various structures within the turbine section. A portion of the cooling fluid is flowed through the turbine airfoils, which have internal passageways for the passage of cooling fluid.

An airfoil of a turbine usually comprises a trailing edge, a leading edge and a suction side wall and a pressure side wall both extending axially between the leading edge and the trailing edge. The trailing edge of a cooled vane or blade is usually provided with a cut-back consisting in the suction side wall extending further downstream of the pressure side wall.

As the cooling flow passes through the passageways from the airfoil, heat is transferred from the turbine airfoil surfaces to the cooling fluid. The passageways include a variety of mechanisms, such as trip strips and pedestals, to maximize heat transfer between the cooling fluid and the turbine airfoil. The cooling fluid exits into the flow path through cooling holes distributed about the airfoil section of the turbine airfoil.

The trailing edge of cooled airfoils is typically cooled by either cast slots or film holes on the airfoil pressure side. Cast slots present a better performance than film holes since they are able to provide higher and more uniform cooling effectiveness profiles across the airfoil span due to their continuous tangential injection of the cooling further downstream closer to the airfoil trailing edge.

However, the use of cast slots is restricted to relatively large cooling flow applications since its large flow areas do not guarantee enough backflow pressure margin for low applications. In this regard, the associated large flow areas, which are dictated by the achievable manufacturing minimum slot height values, do not guarantee enough backflow pressure margin for low flow applications.

Sometimes, for cooling airfoils, a row of film holes for low cooling flow applications in low pressure and intermediate pressure vanes is used. A row of film holes offers several disadvantages over a cast slot. On one hand, the average film effectiveness is lower and the distribution of such effectiveness across the airfoil span is less uniform. On the other hand, the film holes are not cast but machined on the airfoil pressure side wall which restricts both the minimum inclination angle achievable (the lower the angle the higher the cooling effectiveness) and the position of cooling ejection which cannot be as close to the airfoil trailing edge as cast slots can thus reducing the capability of heat removal from the trailing edge.

However, applications with cast slots such as that described in document EP4105441A1, can also improve the uniformity of the cooling distribution but include other limitations such as being more massive hence more difficult to cool and present a weaker cast core hence increasing the manufacturing scrap rate.

Therefore, the present invention provides an improved cooled airfoil that provides a film cooling architecture for low flow cooling applications and at the same time improves the control on backflow margin.

### SUMMARY

The present invention provides an alternative solution for the aforementioned problems, by an airfoil according to claim 1, a turbine blade according to claim 13, a turbine vane according to claim 14 and a turbine engine according to claim 15. Preferred embodiments of the invention are defined in dependent claims.

In a first inventive aspect, the invention provides an airfoil comprising:
a leading edge and a trailing edge, the trailing edge being located axially downstream from the leading edge according to a flow direction that corresponds to the direction of an air flow;
a suction side wall and a pressure side wall both extending axially between the leading edge and the trailing edge, the suction side wall being spaced from the pressure side wall and defining between them a central cavity of the airfoil, the central cavity being configured to allow the passage of cooling flow inside the airfoil;
two side walls extending perpendicular to the flow direction and located between the suction side wall and the pressure side wall;
a cavity region formed in the central cavity between the suction side wall and the pressure side wall, said cavity region extending axially between the leading edge and the trailing edge, being the cavity region proximal to the trailing edge;

wherein the cavity region comprises:
at least a pair of a V-shaped straight ribs extending axially towards the trailing edge,
at least one narrow hole proximal to the trailing edge and bounded by proximal ends of the pair of straight ribs,
at least one wide hole distal to the trailing edge and bounded by the distal ends of the pair of straight ribs,

wherein:
the surface of the at least one narrow hole is smaller than the surface of the at least one wide hole, and
at least one nozzle duct and at least one diffusing duct formed between each of the at least one pair of V-shaped straight ribs or between one V-shaped straight rib and one of the side walls;
wherein the at least one nozzle duct and the at least one diffusing duct are bounded by the at least one narrow hole and by the at least one wide hole.

In the invention, the leading edge of an airfoil is a front part of the airfoil, which is a portion that meets an external hot flow first when it is flowing outside the airfoil when said airfoil is in operating mode, whereas the trailing edge is the back part of the airfoil that is located axially downstream from the leading edge according to a flow direction F.

Through the entire description, the “flow direction” will be understood as the flow direction that corresponds to the direction of an external hot flow surrounding the airfoil when it is in operating mode, that is, a direction from the leading edge to the trailing edge of the airfoil.

The airfoil comprises a suction side wall and a pressure side wall that partially meet at the trailing edge of the airfoil. The suction wall is generally associated with higher velocity and lower static pressure, whereas the pressure wall has a comparatively higher static pressure than the suction wall. In an embodiment of the invention, the suction side wall and a pressure side wall are partially parallel.

At the ends of the length of the airfoil, there are two side walls which extend perpendicularly to the flow direction between the suction side wall and the pressure side wall.

Between the suction side wall and the pressure side wall, a central interior cavity for the airfoil is defined for the passage of cooling flow inside the airfoil. The cavity extends axially between the leading edge and the trailing edge, being the cavity region proximal to the trailing edge. Specifically, the cavity region extends axially since the wide and narrow holes of formed ducts between the V-shaped ribs in the trailing edge until the leading edge. This cavity is an open cavity that allows the passage of cooling flow inside the airfoil and the ejection of the cooling flow over a slot formed above the trailing edge in order to cool the airfoil at the trailing edge.

The airfoil slot is located in the space between the suction sidewall and the pressure sidewall, i.e. it is located at the trailing edge where the suction sidewall and the pressure sidewall come close to meeting.

Cooling flow is circulated through the cavity to cool the trailing edge of the airfoil. This is due to the high temperatures of the fluid coming from the combustion chamber that passes through the external surfaces of the suction side wall and the pressure side wall of the airfoil. The cooling flow is removed from the compressor and transported through the internal engine structures to the airfoil inlet.

The airfoil further comprises a row of a plurality of a pair of a V-shaped straight ribs located at the trailing edge of the airfoil and wherein these V-shaped straight ribs are arranged at least partially in the central cavity between the pressure side wall and the suction side wall of the airfoil. Throughout all this document, “V-shaped straight ribs” concept will be understood as V-shaped walls or protrusions arranged between a suction side wall and a pressure side wall, extending from the trailing edge toward the center of the cavity. Also, such a V-shape is understood to mean that the walls or protrusions form an acute angle with respect to each other.

That is, one side of a pair of a V-shaped straight ribs is referred as “wide hole”, while the opposite side of the pair of a V-shaped straight ribs is referred as “narrow hole”. These sides are oriented or faced to the leading edge or to the trailing edge of the airfoil according to the flow direction F.

Specifically, the at least one narrow hole is bounded by proximal ends of the pair of straight ribs and at least one wide hole is bounded by the distal ends of the pair of straight ribs, wherein the surface of the at least one narrow hole is smaller than the surface of the at least one wide hole.

In the invention, a duct is formed between each a pair of V-shaped straight ribs and bounded by the at least one narrow hole and by the at least one wide hole. The duct allows the cooling flow to pass from the central cavity of the airfoil to the outside of the airfoil at the trailing edge, where the cooling flow mixes with the hot flow.

Moreover, in the simplest cases in which the airfoil only comprises a pair of V-shaped straight ribs, at least one central duct is formed between the V-shaped ribs and at least two more lateral ducts are formed between a straight rib and the side wall. In embodiments wherein the airfoil comprises more than one pair of V-shaped pair of straight ribs, there is an additional duct between each consecutive rib of a pair of V-shaped straight ribs, in addition to those formed with the side walls.

In the simplest cases, the pair of V-shaped straight ribs form a central duct, which comprises the narrow hole oriented or facing towards the trailing edge (i.e. downstream according to the flow direction) when the pair of V-shaped straight ribs behave as a nozzle; or alternatively, the narrow hole is oriented or facing towards the leading edge (i.e., upstream according to the flow direction) when the pair of V-shaped straight ribs behave as a diffuser.

In this way, the behavior of a duct as a nozzle or as a diffuser depends on the areas of the holes of said duct and the direction of the flow. Particularly, in a nozzle duct, the air flow goes from the wide hole to the narrow hole. Conversely, in a diffusing duct, the air flow goes from the narrow hole to the wide hole.

The diffuser duct decreases the airflow velocity but increases the static pressure, while the nozzle duct increases the airflow velocity and decreases the static pressure.

These two types of ducts, nozzles and diffusers, are located alternately in the cavity region, and allow to control the backflow margin in low cooling flow applications, to minimise the risk of the cast process and to improve convective cooling by increasing the wetted areas.

The cooling flow exiting a duct through its outlet zone diffuses laterally until the cooling flow eventually merges with the cooling flow exiting the other ducts thus providing merger between the cooling flow and the hot flow in the slot of the trailing edge.

The V-shape overcomes some problems of the prior art diffuser grooves and offers the additional advantage of castability during manufacturing, since a less massive, stronger and simpler core is obtained in the trailing edge area. In addition to improving the thermal behaviour of the bearing surface, and due to the smaller metal volume, the convective cooling is improved by increasing the wetted areas and minimizing the effects of transients and temperature gradients.

Furthermore, since the V-ribs are arranged above the trailing edge, two parallel rows of holes are formed. One row of the holes is located upstream and the other row of holes is located downstream, closer to the trailing edge.

On one hand, the narrow holes through which the cooling flow comes out, form a row of nozzles that allow the velocity to be increased at the expense of a lower pressure. On the other hand, the narrow holes through which the cooling flow comes in, form a row of diffusers that increase the pressure of a fluid by decelerating it.

Therefore, a duct comprises a narrow hole at one end and a wide hole at the other end so that, depending the flow direction and the orientation of the holes, a nozzle or a throat diffuser type behavior is generated in each duct, whereby the cavity pressure upstream of the ribs is increased relative to a pure slot outlet airfoil configuration due to its smaller effective flow area thus increasing the margin of backflow control.

A pure slot outlet airfoil configuration is defined as an airfoil with no ribs.

The backflow margin requirement is to introduce a minimum pressure ratio (typically around 7%) in the discharge holes to prevent local backflow ingestion of the hot gas stream into the blade trailing edge cavity.

This invention is conceived primarily for low flow cooling applications, which require a relatively small hole area at the cooling flow outlet proximal to the trailing edge, namely towards the air flow direction to ensure an adequate backflow margin. The aim is to ensure a minimum pressure ratio to avoid hot flow ingestion inside the duct in an upstream direction induced by radial pressure variations.

Throughout this document, a low flow (i.e. low flow rate) application is regarded as having an overall cooling effectiveness (from now on E) lower than 0.25, wherein ε is defined as,

$$ε = \frac{{T}_{g} - {T}_{m}}{{T}_{g} - {T}_{c}} ,$$

wherein T_{g} is the mean slot exit hot gas temperature, Tₘ is the local slot allowable mean wall temperature and T_{c} is the mean slot exit cooling temperature.

With all of the above, the invention provides a small cooling outlet area that can ensure control of the backflow margin in low cooling flow rate applications.

In a particular embodiment, the height of each pair of straight ribs decreases towards the downstream direction.

In this embodiment, the central cavity comprises a height that decreases in the flow direction F. Therefore, the pressure side wall and the suction side wall of the airfoil, which determine the central cavity inside the airfoil, converge in the flow direction F by decreasing the space between both side walls until forming the slot in the trailing edge.

The decrease in the height of the central cavity along the flow direction F allows for greater lateral diffusion, achieving duct merger in a shorter length. In this way and through merger between cooling flows, a uniform cooling flow is achieved along the airfoil trailing edge.

In another embodiment, the airfoil comprises a plurality of pair of a V-shaped straight ribs arranged parallel along the entire trailing edge.

For example, when more than two pair of V-shaped straight ribs arranged along the entire trailing edge, every two pairs of ribs create three ducts: a central duct formed by the V-shaped ribs; and two lateral ducts which are formed by a rib of the pair of V-shaped ribs and a consecutive rib, or by a rib and a side wall of the airfoil.

Continuing the example, the central ducts formed by two pair of straight V-shaped ribs comprise:
at least one narrow hole downstream and at least one wide hole upstream and the lateral ducts comprise at least one narrow hole upstream and at least one wide hole downstream; or
at least one central duct with at least one wide hole downstream and at least one narrow hole upstream and the lateral ducts comprise at least one wide hole upstream and at least one narrow hole downstream,
so that the cooling flow enters through the holes upstream and exits through the holes downstream in the flow direction. Advantageously, any of these configurations allow controlling pressure drops and achieving uniformity of the cooling flow and avoiding the backflow of hot air.

As mentioned above, in the invention each pair of straight V-shaped ribs forms a duct configured as a nozzle or a diffuser depending on where the narrow hole or wide holes are, behaving as a nozzle when the narrow hole is downstream and as a diffuser when the narrow hole is upstream. However, when there is a plurality of V-shaped straight ribs in the invention, a plurality of ducts is generated by each consecutive rib of a pair of V-shaped straight ribs, thereby generating a plurality of holes in the row upstream of one of the ends of the ribs and downstream of the other ends of the ribs in the slot of the trailing edge. Thus, when there is a plurality of ducts, the ducts comprise narrow and wide holes alternately upstream and downstream.

Therefore, each duct of the invention comprises an inlet hole and an outlet hole, through which the cooling flow circulating inside the cavity enters and exits. These inlets and outlets are narrow or wide holes arranged alternately along the airfoil.

Fortunately, thanks to the alternating row of ducts along the airfoil, the cooling flow is unified in such a way that a positive pressure drop between the inlet hole and outlet narrow hole is achieved, thereby preventing the hot flow from entering through the slot upstream of the narrow holes.

In another embodiment, the height of the cavity region is determined by the distance between the suction side wall and the pressure side wall.

In a particular embodiment, the cavity region comprises a slot for cooling purpose in the trailing edge with a height of at least 0.7 mm. In this embodiment, the height of the trailing edge slot extending along the trailing edge is limited to a minimum value of 0.7 mm.

Throughout the description, the width of the airfoil is defined as the distance between the leading edge and the trailing edge in the flow direction F, and the length of the airfoil is measured in a longitudinal direction perpendicular to the flow direction. On the other hand, the height of the slot or the height of the airfoil is taken to be the distance between the suction wall and the pressure wall in a transversal direction, perpendicular to the flow direction (i.e. perpendicular to the longitudinal direction).

Since a minimum slot height of 0.7 mm results in too large a discharge area for low flow applications, at least one duct consisting of at least one pair of straight ribs is required.

A relatively small duct area at the cooling flow outlet must be obtained to achieve a pressure ratio of 1.05-1.08 that maintains the backflow margin and makes the cooling flow outlet flow rate uniform.

In an embodiment, the number of pairs of V-shaped straight ribs depends on the length of the trailing edge of the airfoil and on the relative angle between adjacent ribs.

The number of pairs of ribs will depend on the length of the airfoil at the trailing edge, the level of expansion and diffusion achieved in the ducts, which is dictated by the relative angle between adjacent ribs and the flow rate.

In a preferred embodiment, the airfoil comprises between 2 and 10 pairs of V-shaped straight ribs.

In a particular embodiment, the V-shaped straight ribs formed an angle lower than 20° or in other preferred embodiments, the V-shaped straight ribs formed an angle lower than 12°.

The minimum achievable angle and cooling ejection position can thus reduce the heat removal capacity of the trailing edge. In particular, the smaller the angle, the higher the film cooling effectiveness. This is because when the diffusion angle increases, the flow detaches from the walls forming a jet and forming lateral recirculation zones which are not desirable.

In a different embodiment, each V-shaped straight ribs comprises a width between 0.7-1.2 mm.

These dimensions of the straight ribs depend on the volume of the cooling fluid flow that is desired to pass through the at least one conduit. Throughout the description, the dimensions of the straight V-ribs are measured on the pressure wall, i.e. the height of the rib is defined by the distance between the suction wall and the pressure wall and the width of the ribs is determined in the direction perpendicular to the direction of flow.

Furthermore, in the invention, the larger the holes to pass the cooling air, the greater the surface area wetted by said fluid and the volume to be cooled decreases.

In another embodiment the airfoil further comprises a plurality of pedestals that are located between the leading edge and the cavity region and upstream of the ribs. Preferably, said pedestals comprise fillet joints configured to join said pedestals with the suction side wall and the pressure side wall.

The pedestals are cylinders that join the suction side wall and the pressure side wall.

In a particular embodiment, the airfoil is made of a material comprising nickel.

Nickel-based materials help withstand high working temperatures, like in the turbine airfoils.

In a particular embodiment, the V-shaped straight ribs comprise fillet joints configured to join said V-shaped straight ribs with the suction side wall and the pressure side wall.

The fillet joints help reducing mechanical stresses in 90° joints, for example, the joints between the pedestals with the suction side wall and the pressure side wall or between V-shaped straight ribs with the suction side wall and the pressure side wall. Preferably, the fillet joints are rounded-shaped, and have a radius in the range of 0.15-0.25 mm.

In a second inventive aspect, the invention provides a turbine blade comprising an airfoil as described above.

This turbine blade with the airfoil based on the configuration of straight V-shaped ribs, improves the cooling of the airfoil because this configuration favors control over pressure drops and the uniform distribution of the cooling fluid as it exits through the trailing edge preventing backflow of hot air into the airfoil.

In a third inventive aspect, the invention provides a turbine vane comprising an airfoil as described above, which makes it possible to improve the cooling conditions as in the turbine blade.

In a fourth inventive aspect, the invention provides a turbine engine comprising an airfoil according to the first aspect. Said turbine engine is not limited for its use in an aircraft but also in other applications, such as power generation.

This V-shaped straight rib concept offers the additional benefit of a less massive concept in the trailing edge area of the airfoil. This concept minimises the risk of the cast process and improves the convective cooling increasing wetted areas and minimising temperature transient and gradient effects.

Moreover, a lower mass configuration in a piece or part of an aircraft (such as the turbine engine) generally implies lower weight and volume, which favours the operation of the entire assembly in the aeronautical sector.

All the features described in this specification (including the claims, description and drawings) and/or all the steps of the described method can be combined in any combination, with the exception of combinations of such mutually exclusive features and/or steps.

### APPENDIX

This application is filed with an appendix, herein incorporated by reference in its entirety. Unless aspects of the appendix are later amended into the present application, nothing in the appendix forms part of the claimed invention.

### BRIEF DESCRIPTION OF THE DRAWINGS

These and other characteristics and advantages of the invention will become clearly understood in view of the detailed description of the invention which becomes apparent from a preferred embodiment of the invention, given just as an example and not being limited thereto, with reference to the drawings.

FIG. 1 This figure shows a schematic perspective view of an airfoil.

FIG. 2 This figure shows a perspective view of the profile of an airfoil of the invention.

FIG. 3 This figure shows a plan view of a longitudinal section of an airfoil.

FIG. 4 This figure shows a perspective of a transversal section of an airfoil.

FIG. 5 This figure shows a plan view of a longitudinal section of the simplest airfoil according to the invention, only having a pair of V-shaped ribs delimiting a central duct behaving as a nozzle.

FIG. 6 This figure shows a plan view of a longitudinal section of the simplest airfoil according to the invention, only having a pair of V-shaped ribs delimiting a central duct behaving as a diffuser.

### DETAILED DESCRIPTION

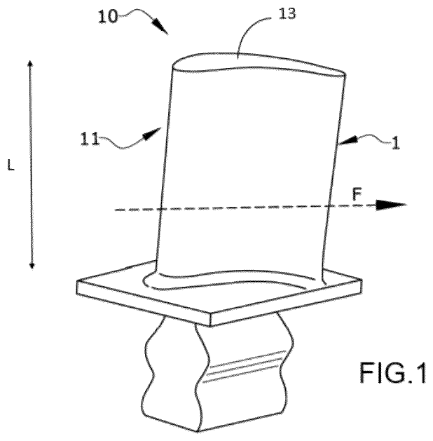

FIG. 1 shows a schematic representation of an airfoil (10) for a turbine engine. The airfoil (10) comprises a leading edge (11) and a trailing edge (1) shown in FIG. 1. The trailing edge (1) is located axially downstream from the leading edge (11) according to a flow direction F. The flow direction F corresponds to the direction of the hot flow flowing externally to the airfoil (10) when the airfoil (10) is in operating mode.

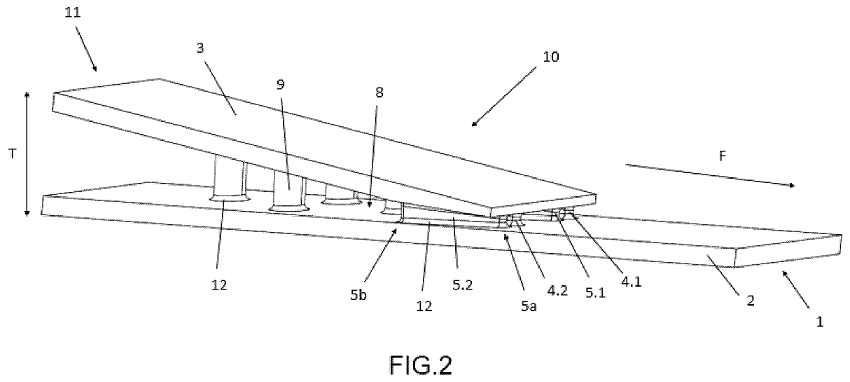

FIGS. 2, 3 and 4 show a partial representation of an airfoil (10) according to the present invention.

The airfoil (10) from these figures comprises a suction side wall (2) and a pressure side wall (3) in a transversal direction (T) as can be observed in FIG. 2, wherein both of these walls (2, 3) are extending between the leading edge (11) and the trailing edge (1) without touching each other. A central interior cavity (8) for each airfoil (10) is defined between the suction side wall (2) and the pressure side wall (3). This cavity is an open cavity in order to allow the passage of cooling flow inside the airfoil (10) and the ejection of the cooling flow over the trailing edge (1).

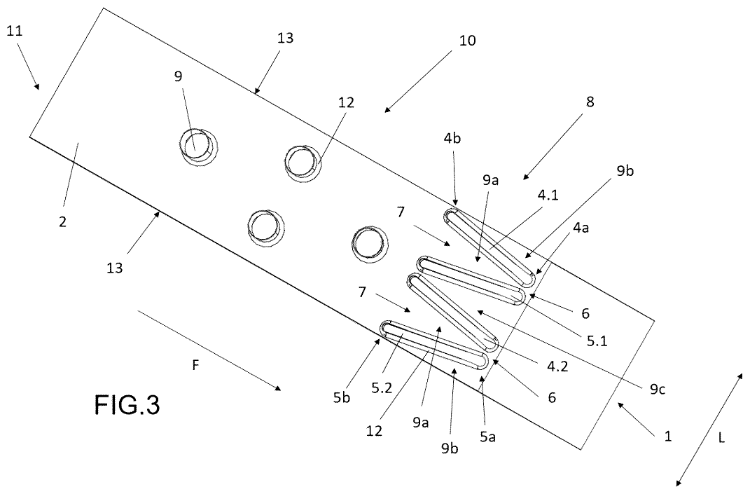

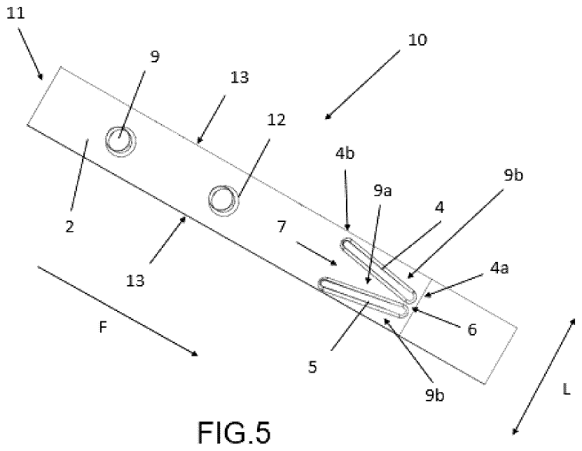

Also, the airfoil (10) comprises side walls (13) defined in a longitudinal direction perpendicular to the flow direction F as can be observed in FIGS. 3 and 5.

Each airfoil (10) comprises a row of a pair of a V-shaped straight ribs (4, 5) extending axially towards the trailing edge (1). The V-shaped straight ribs (4, 5) are arranged at least partially between the suction side wall (2) and the pressure side wall (3) forming a duct (9a) between the pair of straight ribs (4, 5).

Each duct (9a) formed by the pair of V-shaped straight ribs (4, 5) comprises:
at least one narrow hole (6) downstream which is a cross hole proximal to the trailing edge (1) and limited by the proximal ends (4a, 5a) of the pair of V-shaped straight ribs (4, 5), and
at least one wide hole (7) upstream which is a cross hole distal to the trailing edge (1) and limited by the distal ends (4b, 5b) of the pair of straight ribs (4, 5), such that the surface of the at least one narrow hole (6) is smaller than the surface of the at least one wide hole (7). These ducts (9a) allow the passage of the cooling flow from the central cavity of the airfoil (10) to the outside of the airfoil (10) at the trailing edge (1).

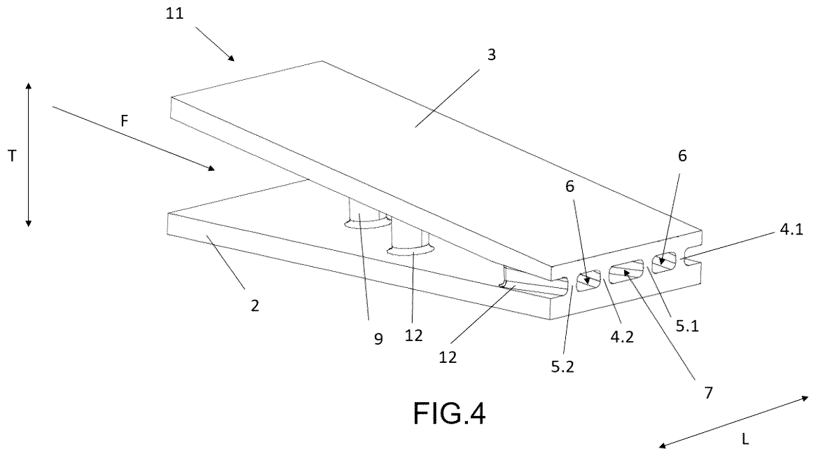

FIGS. 2 and 4 show that the central cavity comprises a height measured in the transversal direction (T) that decreases along the flow direction F. The suction side wall (2) and the pressure side wall (3), determining the central cavity which converges in the flow direction (F) reducing the space between both side walls when approaching the trailing edge (1).

Therefore, the height of the cavity region (8) and therefore that of each pair of straight ribs (4, 5) also decreases in the direction of flow towards the downstream trailing edge (1).

This decrease in the cavity causes the holes (7) created upstream by the distal ends of the pair of straight V-shaped ribs (4b, 5b) to be larger than the holes (6) created downstream by the proximal ends of the pair of straight V-shaped ribs (4a, 5a).

In view of the figures, it is understood that the airfoil (10) may comprise a plurality of pairs of straight V-shaped ribs (4, 5) arranged along the entire length of the trailing edge in a longitudinal direction (L). Specifically, the FIGS. 2 to 4 show a piece of airfoil (10) with only two pairs of straight V-shaped ribs (4.1, 5.1, 4.2, 5.2) for greater clarity of the explanations.

FIG. 5 shows another airfoil (10) according to the invention which comprises only a pair of V-shaped ribs (4, 5). The embodiment of FIG. 5 leads to the shortest configuration, as it only has a couple of V-shaped ribs (4, 5) which define a central duct behaving as a nozzle.

The number of pairs of a V-shaped straight ribs (4, 5) depends on the length of the trailing edge (1) of the airfoil (10).

Although it depends on the length the trailing edge (1) of the airfoil (10) more specifically it depends on the configuration of the ribs (4, 5), that is, the distance between each pair of ribs (4, 5) and the angle between each pair of V-shaped straight ribs (4, 5). The skilled person will be able to adapt the angle and distance of the invention depending on requirements of the specific application where it is going to be used.

As can be observed in FIG. 5, a pair of V-shaped ribs (4, 5) form three ducts: one central nozzle duct (9a) between the pair of V-shaped ribs (4, 5) and two lateral diffusing ducts (9b) between each rib and each of the side walls (13).

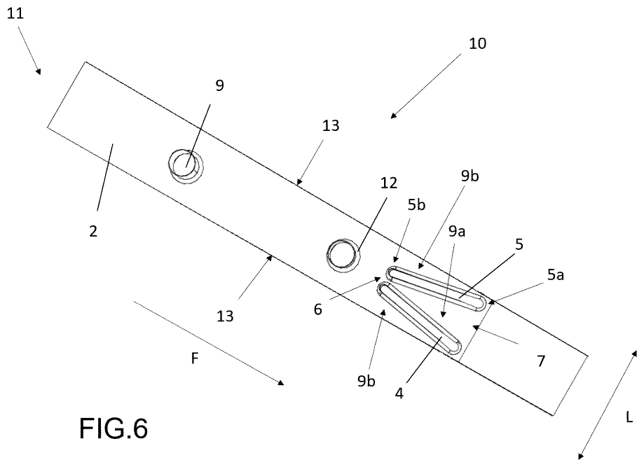

An alternative embodiment is shown in FIG. 6, which comprises a couple of V-shaped ribs (4, 5) behaving as a diffuser. In other words, a central duct (9a) is defined by the V-shaped ribs (4, 5) and operates as a diffuser. The pair of V-shaped ribs (4, 5) form three ducts: one central diffusing duct (9a) between the pair of V-shaped ribs (4, 5) and two lateral nozzle ducts (9b) between each rib and each of the side walls (13). This is also the simplest configuration according to the invention.

In this way, FIGS. 5 and 6 illustrate the simplest cases according to the invention, by only using only a pair of V-shaped ribs.

On the other hand, when two pairs (4.1, 5.1, 4.2, 5.2) of V-shaped straight ribs (4, 5) are used (see FIGS. 2 to 4), five ducts are formed:
two nozzle ducts (9a) between each of pairs of V-shaped straight ribs (4.1, 5.1, 4.2, 5.2),
a central diffusing duct (9c) between the pair V-shaped straight ribs (4, 5), more specifically, between rib (5.1) and rib (4.2) and
two lateral diffusing ducts (9b) between one rib (4.1, 5.2) and each of the side wall (13).

The nozzle ducts (9a) are arranged between ribs (4.1, 5.1) and ribs (4.2, 5.2) and comprise a configuration as described above. That is, the nozzle ducts (9a) comprise:
at least one narrow hole (6) downstream, which is limited by the proximal ends (4.1a, 5.1a, 4.2a, 5.2a) of the V-shaped straight ribs (4.1, 5.1, 4.2, 5.2) and
at least one wide hole (7) upstream, which is limited by the distal ends (4.1b, 5.1b, 4.2b, 5.2b) of the V-shaped straight ribs (4.1, 5.1, 4.2, 5.2).

On the contrary, the central diffusing duct (9c) is between rib (5.1) of a first pair of V-shaped straight ribs (4.1, 5.1) and the rib (4.2) of a second pair V-shaped straight ribs (4.2, 5.2) and comprises an opposite configuration to that, which is formed by the pairs of V-shaped ribs (4.1, 5.1, 4.2, 5.2). That is, the central diffusing duct (9c) comprises:
at least one narrow hole (6) upstream which is distal to the trailing edge (1) and is limited by the distal ends (4.2b, 5.1b) of the pair of V-shaped straight ribs (4, 5) and
at least one wide hole (7) downstream which is proximal to the trailing edge (1) and is limited by the proximal ends (4.2a, 5.1a) of the pair of straight ribs (4, 5).

In addition, the lateral diffusing ducts (9b) are between rib (4.1) of a first pair V-shaped straight ribs (4.1, 5.1) or rib (5.2) of a second pair V-shaped straight ribs (4.2, 5.2) and the side wall (13). The lateral diffusing duct (9b) comprises the same configuration as a central diffusing duct (9c), that is, at least one narrow hole (6) upstream which is distal to the trailing edge (1) and limited by the distal ends (4.1b, 5.2b) of the pair of V-shaped straight ribs (4, 5) and at least one wide hole (7) downstream which is proximal to the trailing edge (1) and limited by the proximal ends (4.1a, 5.2a) of the pair of straight ribs (4, 5).

In embodiments wherein more than two pairs of V-shaped ribs (4, 5) are employed, alternating nozzle and diffusing ducts are defined every two pairs of V-shaped ribs, as explained above.

The combination of narrow hole (6) and wide hole (7) form at least two rows as can be seen in FIGS. 2 to 5. The ducts (9a, 9b) and holes (6, 7) of the cavity increase the pressure drop from the cavity to the slot of the trailing edge (1), thereby increasing the backflow margin control.

In a preferred embodiment, the cavity region (8) comprises a slot in the trailing edge (1) of at least a height of 0.7 mm.

Furthermore, for low flow cooling applications, like the ones for which the invention is devised, sufficiently small areas of the nozzle and the diffuser at the exit of the cooling flow towards the hot gas path are required.

Thanks to the straight V-shaped ribs, the control of the areas of the nozzle(s) and the diffuser(s) is facilitated to ensure an adequate backflow margin, that is, a minimum pressure ratio to avoid hot gas ingestion induced by radial pressure variations in the upward flow direction (F), from the narrow holes (6) to the leading edge (11).

As mentioned above, it is possible to adapt values of the invention such as the angle, width, height and distance of the pair of V-shaped straight ribs (4, 5) in order to control the backflow margin depending on the particular application where the invention is used.

Because of that, the preferred values for the configuration of the V-shaped straight ribs (4, 5) of the cavity region (8) are a maximum angle of 12° between the ribs (4.1, 5.1 and 4.2, 5.2) and a width of the ribs (4.1, 5.1 and 4.2, 5.2) between 0.7-1.2 mm.

In figures, it can be observed that the airfoil (10) further comprises a plurality of pedestals (9) which are located between the leading edge (11) and the cavity region (8).

The pedestals (9) increase heat transfer in the region where they are located.

The present airfoil (10) is manufactured by a material comprising nickel.

Advantageously, the material used for these applications is nickel-based because it needs to withstand high temperatures when operating.

In a preferred embodiment, at least one of the pedestals (9) and/or at least one of the V-shaped straight ribs (4, 5) comprise a fillet joint (12). More preferably, the fillet joints (12) are rounded-shaped, and have a radius in the range of 0.15-0.25 mm. Even more preferably, the radius of the fillet joints (12) is 0.2 mm.

Advantageously, the fillet joints (12) avoid mechanical stresses in 90° joints and prevent the airfoil (10) from breaking in these areas.

1. An airfoil (10) comprising:
a leading edge (11) and a trailing edge (1), the trailing edge (1) being located axially downstream from the leading edge (11) according to a flow direction that corresponds to the direction of an air flow;
a suction side wall (2) and a pressure side wall (3), both walls (2, 3) extending axially between the leading edge (11) and the trailing edge (1), the suction side wall (2) being spaced from the pressure side wall (3) and defining between them a central cavity of the airfoil (10), the central cavity being configured to allow the passage of a cooling flow inside the airfoil (10);
two side walls (13) extending perpendicular to the flow direction and located between the suction side wall (2) and the pressure side wall (3);
a cavity region (8) formed in the central cavity between the suction side wall (2) and the pressure side wall (3), said cavity region (8) extending axially between the leading edge (11) and the trailing edge (1), being the cavity region (8) proximal to the trailing edge (1);
wherein the cavity region (8) comprises:
at least a pair of a V-shaped straight ribs (4, 5) extending axially towards the trailing edge (1),
at least one narrow hole (6) proximal to the trailing edge (1) and bounded by proximal ends (4a, 5a) of the pair of straight ribs (4, 5),
at least one wide hole (7) distal to the trailing edge (1) and bounded by the distal ends (4b, 5b) of the pair of straight ribs (4, 5), and
wherein:
the surface of the at least one narrow hole (6) is smaller than the surface of the at least one wide hole (7), and
at least one nozzle duct (9a) and at least one diffusing duct (9b) formed between each of the at least one pair of V-shaped straight ribs (4, 5), or between one V-shaped straight rib (4, 5) and one of the side walls (13);
wherein the at least one nozzle duct (9a) and the at least one diffusing duct (9b) are bounded by the at least one narrow hole (6) and by the at least one wide hole (7).

2. An airfoil (10) according to claim 1, wherein the height of each pair of straight ribs (4, 5) decreases towards the downstream direction.

3. An airfoil (10) according to claim 1, wherein the airfoil comprises a plurality of pair of a V-shaped straight ribs (4, 5) arranged along the entire trailing edge (1).

4. An airfoil (10) according to claim 1, wherein the height of the cavity region (8) is determined by the distance between the suction side wall (2) and the pressure side wall (3).

5. An airfoil (10) according to claim 1, wherein the cavity region (8) comprises a slot (8a) in the trailing edge (1) of a at least a height of 0.7 mm.

6. An airfoil (10) according to claim 1, wherein the number of pairs of a V-shaped straight ribs (4, 5) depends on the length of the trailing edge (1) of the airfoil (10) and on the relative angle between adjacent V-shaped straight ribs (4,5).

7. An airfoil (10) according to claim 1, wherein the V-shaped straight ribs (4, 5) formed an angle lower than 20°.

8. An airfoil (10) according to claim 1, wherein the V-shaped straight ribs (4, 5) formed an angle lower than 12°.

9. An airfoil (10) according to claim 1, wherein the width of each of the V-shaped straight ribs (4, 5) is comprised between 0.7-1.2 mm.

10. An airfoil (10) according to claim 1, wherein the airfoil (10) further comprises a plurality of pedestals (9) that are located between the leading edge (11) and the cavity region (8), said pedestals (9) being placed upstream of the V-shaped straight ribs (4, 5), and preferably wherein the pedestals (9) comprise fillet joints (12) configured to join said pedestals (9) with the suction side wall (2) and the pressure side wall (3).

11. An airfoil (10) according to claim 1, wherein the airfoil (10) is made of a material comprising nickel.

12. An airfoil (10) according to claim 1, wherein the V-shaped straight ribs (4, 5) comprise fillet joints (12) configured to join said V-shaped straight ribs (4, 5) with the suction side wall (2) and the pressure side wall (3).

13. A turbine blade comprising an airfoil (10) according to claim 1.

14. A turbine vane comprising an airfoil (10) according to claim 1.

15. A turbine engine comprising an airfoil (10) according to claim 1.
